(19) United States
(12) Patent Application Publication
(10) Pub. No.: US 2026/0031909 A1
(43) Pub. Date: Jan. 29, 2026

(54) APPARATUS AND METHOD FOR TRANSMITTING AND RECEIVING OPTICAL SIGNAL IN COHERENT OPTICAL COMMUNICATION SYSTEM

(71) Applicant: ELECTRONICS AND TELECOMMUNICATIONS RESEARCH INSTITUTE, Daejeon (KR)

(72) Inventors: Sun Hyok CHANG, Daejeon (KR); Hun Sik KANG, Daejeon (KR); Jong Wan KIM, Daejeon (KR); Sang Rok MOON, Daejeon (KR)

(73) Assignee: ELECTRONICS AND TELECOMMUNICATIONS RESEARCH INSTITUTE, Daejeon (KR)

(21) Appl. No.: 19/276,700

(22) Filed: Jul. 22, 2025

(30) Foreign Application Priority Data
Jul. 23, 2024 (KR) 10-2024-0097179

(51) Int. Cl. H04B 10/25; H04B 10/50; H04B 10/61; H04J 14/02

(52) U.S. Cl. CPC H04B 10/2589; H04B 10/503; H04B 10/61; H04J 14/02

(57) ABSTRACT

The present disclosure enables bi-directional optical transmission in a single optical fiber link using the same wavelength, thereby preventing transmission performance from being reduced due to the influence of back-reflection in an optical fiber, an optical connector, an optical element, or the like. An embodiment of the present disclosure is a method for transmitting and receiving an optical signal in a coherent optical communication system, including: transmitting, from a first transceiver, a first optical signal set to a first wavelength to a second transceiver; and receiving, from the second transceiver, a second optical signal set to the first wavelength.

### CROSS-REFERENCE TO RELATED APPLICATIONS

This application is based on, and claims priority from, Korean Patent Application Number 10-2024-0097179, filed Jul. 23, 2024, the disclosure of which is incorporated by reference herein in its entirety.

### TECHNICAL FIELD

The present disclosure relates to an apparatus and a method for transmitting and receiving an optical signal in a coherent optical communication system.

### BACKGROUND

The content described below merely provides background information related to this embodiment, and does not constitute the related art.

In recent years, a high-speed signal optical transmission technology of 400 Gbps or more using a single wavelength has been developed, and a coherent optical transmission/reception technology has been widely used in such high-speed optical transmission.

Korean Registered Patent No. 10-2048759 discloses a method in which a laser output is branched at a transmitting end and transmitted to a receiving end using a separate optical fiber. This transmission method may match the wavelength of the signal sent from the transmitting end with the wavelength of the local oscillator (LO) used at the receiving end. However, since separate optical fiber links are required here, this transmission method may not be applied in a limited number of optical fiber link environments.

### SUMMARY

The present disclosure provides an apparatus and method for enabling bi-directional optical transmission in a single optical fiber link using the same wavelength.

The problems to be solved by the present disclosure are not limited to the above-mentioned problems, and other problems that are not mentioned will be clearly understood by those skilled in the art from the following description.

An embodiment of the present disclosure is a method for transmitting and receiving an optical signal in a coherent optical communication system, including: transmitting, from a first transceiver, a first optical signal set to a first wavelength to a second transceiver; and receiving, from the second transceiver, a second optical signal set to the first wavelength.

An embodiment of the present disclosure provides an apparatus for transmitting and receiving the optical signal in a coherent optical communication system, including: a memory including instructions; and a processor that, by execution of the instructions, transmits, from a first transceiver, the first optical signal set to a first wavelength to a second transceiver, and receives, from the second transceiver, the second optical signal set to the first wavelength.

The present disclosure enables bi-directional optical transmission of the optical signal in a single optical fiber link using the same wavelength, thereby preventing transmission performance from being reduced due to the influence of back-reflection in an optical fiber, an optical connector, an optical element, or the like.

In the present disclosure, the number of laser light sources is limited to one, so that the cost of the optical transceiver may be reduced.

The effects of the present disclosure are not limited to the above-mentioned effects, and other effects that are not mentioned will be clearly understood by those skilled in the art from the following description.

### BRIEF DESCRIPTION OF THE DRAWINGS

FIG. 1 is a schematic diagram of transmitting and receiving optical signals in a bi-directional optical transceiver.

FIG. 2 is a schematic diagram of transmitting and receiving optical signals in the bi-directional optical transceiver using wavelength division multiplexing (WDM) technology.

FIG. 3 shows a block diagram of a coherent optical transceiver.

FIG. 4 is a schematic diagram of an apparatus for transmitting and receiving an optical signal in a coherent optical communication system according to an embodiment of the present disclosure.

FIG. 5 shows a spectrum of an optical signal output applied to an embodiment of the present disclosure.

FIG. 6 is a flowchart of a method for transmitting and receiving the optical signal in a coherent optical communication system according to an embodiment of the present disclosure.

FIGS. 7 and 8 are structural diagrams of a coherent optical transceiver to which an embodiment of the present disclosure is applied.

FIGS. 9 and 10 show other example of a coherent optical transceiver structure to which an embodiment of the present disclosure is applied.

FIGS. 11 and 12 show still other example of a coherent optical transceiver structure to which an embodiment of the present disclosure is applied.

FIGS. 13 and 14 show another example of bi-directional WDM optical transmission to which an embodiment of the present disclosure is applied.

### DETAILED DESCRIPTION

Hereinafter, some embodiments of the present disclosure will be described in detail using exemplary drawings. It should be noted that, in assigning reference numerals to the components of each drawing, the same components are denoted the same numerals as much as possible, even if they are shown in different drawings. In addition, in describing the present disclosure, if it is determined that a specific description of a related known configuration or function may obscure the gist of the present disclosure, the detailed description thereof will be omitted.

In describing components of embodiments of the present disclosure, symbols such as first, second, i), ii), a), and b) may be used. Such symbols are merely for distinguishing the components from other components, and the nature, sequence, order, or the like of the components is not limited by the symbols. In the specification, when a part is said to “include” or “have” a certain component, this means that it may further include other components rather than excluding other components, unless explicitly stated to the contrary.

The detailed description set forth below in conjunction with the appended drawings is intended to describe exemplary embodiments of the disclosure and is not intended to represent the only embodiments in which the disclosure may be practiced.

By a first transceiver is herein meant a first coherent optical transceiver and by a second transceiver is meant a second coherent optical transceiver.

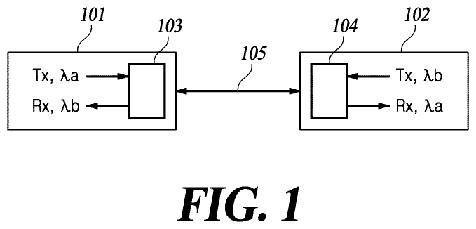

FIG. 1 is a schematic diagram of transmitting and receiving optical signals in a bi-directional optical transceiver.

FIG. 1 shows bi-directional optical transmission using bi-directional optical transceivers 101 and 102.

An optical communication system includes a first bi-directional optical transceiver 101, a single optical fiber link 105, a second bi-directional optical transceiver 102, and the like.

Mobile access networks using mobile fronthaul and backhaul often lack deployed optical fibers for transmission. Therefore, bi-direction optical transmission technology using a single optical fiber link 105 is widely used.

The wavelength λₐ of the optical output Tx of the first bi-directional optical transceiver 101 is different from the wavelength λ_{b} of the optical output Tx of the second bi-directional optical transceiver 102, so that the wavelengths in both directions (upward and downward) are set to be different when the signal passes through the single optical fiber link 105. In the case where the same wavelength is used in both directions, transmission performance deteriorates due to the influence of back-reflection in an optical fiber, an optical connector, an optical element, or the like. In addition, since the degree of deteriorated performance varies depending on the amount of back-reflection, it is difficult to ensure transmission performance.

In the case of FIG. 1, the optical transceiver employs an intensity modulation-direct detection (IM-DD) scheme of modulation and reception, and the optical receiver Rx operates identically over a wide wavelength band, so there is no dependency on the reception wavelength. In other words, reception is possible using the same Rx in the first bi-directional optical transceiver 101 and second bi-directional optical transceiver 102.

A first wavelength-selective optical filter 103 and a second wavelength-selective optical filter 104 may separate or combine different wavelength signals according to directions.

The wavelength λₐ of the optical transmitter Tx of the first bi-directional optical transceiver 101 passes through the single optical fiber link 105 through the first wavelength-selective optical filter 103, and is separated by the second wavelength-selective optical filter 104 and reaches the optical receiver Rx of the second bi-directional optical transceiver 102.

In the opposite direction, the wavelength λ_{b} of the optical transmitter Tx of the second bi-directional optical transceiver 102 passes through the single optical fiber link 105 through the second wavelength-selective optical filter 104.

The signal that has passed through the single optical fiber link 105 is separated by the first wavelength-selective optical filter 103 and reaches the optical receiver Rx of the first bi-directional optical transceiver 101.

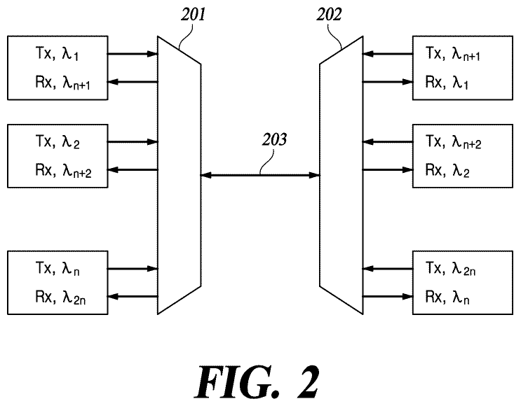

FIG. 2 is a schematic diagram of transmitting and receiving optical signals in the bi-directional optical transceiver using wavelength division multiplexing (WDM) technology.

FIG. 2 shows bi-directional optical transmission using WDM technology.

The optical communication system includes a plurality of first bi-directional optical transceivers, a first WDM optical multiplexer 201, a single optical fiber link 203, a second WDM optical multiplexer 202, a plurality of second bi-directional optical transceivers, and the like.

The output wavelengths λ₁-λₙ of the optical transmitter Tx are each multiplexed in the first WDM optical multiplexer 201 and pass through the single optical fiber link 203.

The signal that has passed through the single optical fiber link 203 is demultiplexed by the second WDM optical multiplexer 202 to be separated into respective wavelengths and to reach the respective optical receivers.

In the opposite direction, the output wavelengths λₙ₊₁˜λ₂ₙ of the optical transmitter Tx are each multiplexed by the second WDM optical multiplexer 202 and pass through the single optical fiber link 203.

The signal that has passed through the single optical fiber link 203 is demultiplexed in the first WDM optical multiplexer 201 to be separated into respective wavelengths and to reach the respective optical receiver Rx.

As described above, in the single optical fiber link 203, one direction is transmitted using λ₁˜λₙ, and the other opposite direction is transmitted using wavelengths of λₙ₊₁˜λ₂ₙ, so that different wavelengths are transmitted in the optical fiber.

Such a bi-directional optical transmission method enables the transmission and reception of bi-directional signals using single optical fiber link, thereby reducing optical fiber usage and providing economic benefits. In recent years, in order to meet the increasing bandwidth demand of high-speed and large-capacity optical networks, high-speed signal optical transmission and reception technology for 400 Gbps or more using a single wavelength has been developed, and in such high-speed optical transmission, coherent optical transceivers have been developed extensively by using a coherent optical transmission and reception technique.

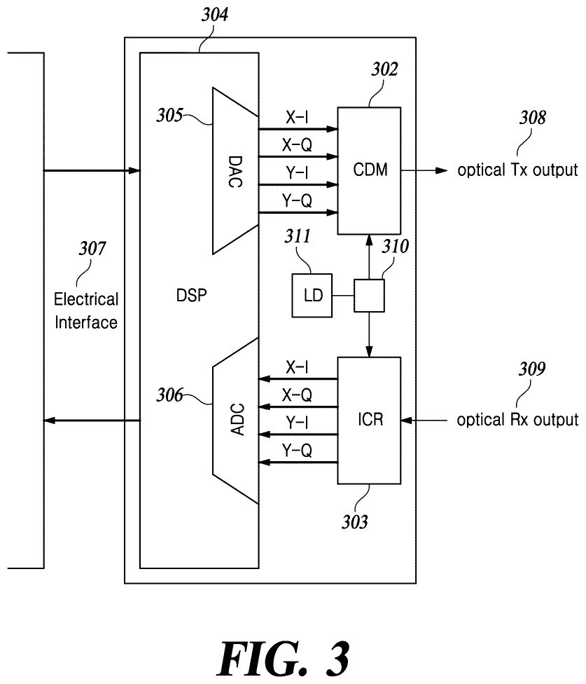

FIG. 3 shows a block diagram of a coherent optical transceiver.

The coherent optical transceiver 301 includes a DSP 304 including a digital-to-analog converter (DAC) 305 and an analog-to-digital converter (ADC) 306, a CDM 302, an ICR 303, an LD 311, an optical splitter 310, and the like.

The coherent driver modulator (CDM) 302 modulates and converts the electrical signals X-I, X-Q, Y-I, Y-Q into optical output.

The integrated coherent receiver (ICR) 303 converts the optical input into electrical signals X-I, X-Q, Y-I, and Y-Q.

The CDM 302 and the ICR 303 are used as optical transmitter Tx and optical receiver Rx, respectively.

The laser diode (LD) 311 corresponds to a laser light source and provides input light.

The optical output of the LD 311 is split by the optical divider 310 to serve as the optical input of the optical transmitter (CDM) 302 and at the same time as the local oscillator (LO) light source of the optical receiver (ICR) 303. In the optical receiver (ICR) 303 the optical input 309 is mixed with the LO light source output to form a received signal.

The digital signal processor (DSP) 304 may compensate for problems occurring in the optical transmission line to improve transmission performance. More specifically, the DSP 304 may not only compensate for chromatic dispersion and polarization mode dispersion of transmission lines, but also compensate for performance degradation due to bandwidth limitations or imperfections of optical transceivers by using digital signal processing.

Since the coherent optical transceiver 301 of FIG. 3 shares the LD 311 in the optical transmitter 302 and the optical receiver 303, the transmission wavelength and the reception wavelength should be the same. When the coherent optical transceiver as shown in FIG. 3 is applied to the bi-directional optical transmission illustrated in FIGS. 1 and 2, the transmission wavelength and the reception wavelength must be the same, and therefore it is difficult to ensure the transmission performance due to the influence of back-reflection in an optical fiber, an optical connector, an optical element, or the like. In order to solve this problem, two laser light sources may be used to use different wavelengths in each of the optical transmitter and the optical receiver, but in this case, there is a problem that the price of the optical transceiver increases by about 30 percent (%) or more.

In the embodiments of the present disclosure, one laser light source is used, the single optical fiber link is used, and the same wavelength is used to ensure bi-directional optical transmission performance using coherent optical transmission and reception.

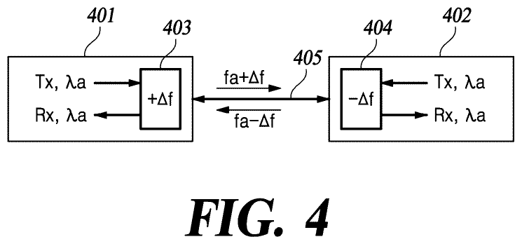

FIG. 4 is a schematic diagram of an apparatus for transmitting and receiving an optical signal in a coherent optical communication system according to an embodiment of the present disclosure.

FIG. 4 shows an example of bi-directional optical transmission method of a coherent optical transceiver according to an embodiment of the present disclosure.

The optical communication system includes a first coherent optical transceiver 401, a single optical fiber link 405, a second coherent optical transceiver 402, and the like.

The first coherent optical transceiver 401 and the second coherent optical transceiver 402 operate at the same light output wavelength λₐ.

A first frequency shifter 403 and a second frequency shifter 404 may perform the role of frequency shift, and may shift a center frequency of the optical signal.

By performing frequency shifting in different directions in the first frequency shifter 403 and the second frequency shifter 404, bi-directional signals that are frequency-shifted in different directions are transmitted and received through a single optical fiber link 405.

For the first coherent optical transceiver 401, the optical output shifts by a frequency of +Δf relative to the original optical output frequency (fa=c/λₐ, where c is the speed of light). Similarly, the second coherent optical transceiver 402 shifts by a frequency of −Δf relative to the original optical output frequency (fa=c/λₐ, where c is the speed of light).

Exemplary computing apparatus to which the present disclosure may be applied include, for example, a memory including instructions, a processor, etc., although not shown in the drawings. Here, the processor is configured to, by execution of the instructions, transmit, from a first transceiver, a first optical signal set to a first wavelength to a second transceiver, and receives, from the second transceiver, a second optical signal set to the first wavelength. The first transceiver is configured to include a first frequency shifter that shifts the first signal in frequency by a predetermined frequency. The second transceiver is configured to include a second frequency shifter that shifts the second signal in frequency by a predetermined frequency. The first transceiver and the second transceiver are connected by a single optical fiber link. The bi-directional signals in the single optical fiber link are frequency-shifted in different directions.

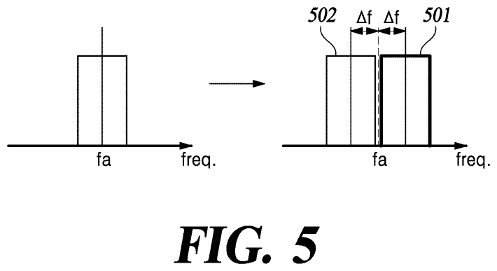

FIG. 5 shows a spectrum of an optical signal output applied to an embodiment of the present disclosure.

The first optical signal spectrum 501 represents the first coherent optical transceiver 401 of FIG. 4. The second optical signal spectrum 502 represents the output of the second coherent optical transceiver 402 of FIG. 4.

The first optical signal spectrum 501 maintains the signal spectrum from overlapping during bidirectional optical transmission in the single optical fiber link 405 by shifting the frequency by Δf. It may be seen that by applying a manner of shifting by the frequency of Δf, the influence by back-reflection is significantly reduced. In addition, the frequency amount of Δf is not sufficient, so that the influence of back-reflection may be significantly reduced even when the first optical signal spectrum 501 and the second optical signal spectrum 502 partially overlap, and the value of Δf may be adjusted according to the situation.

As illustrated in FIGS. 4 and 5, the method for implementing the coherent optical transceiver capable of bi-directional optical transmission may be various, and is not limited thereto.

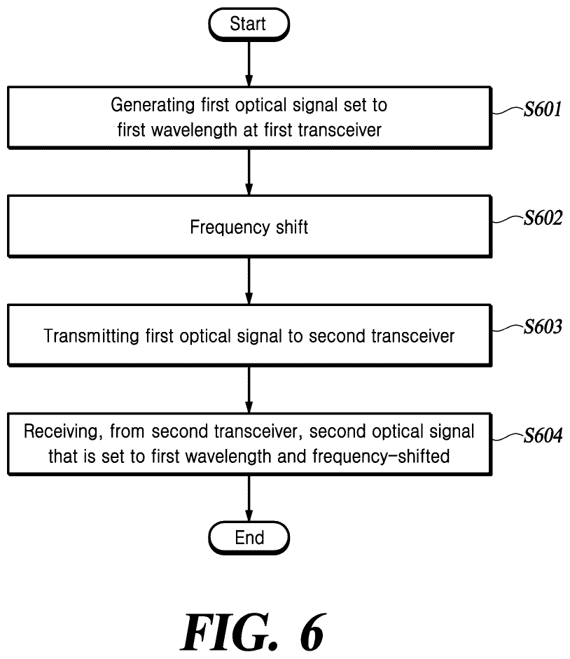

FIG. 6 is a flowchart of a method for transmitting and receiving the optical signal in the coherent optical communication system according to an embodiment of the present disclosure.

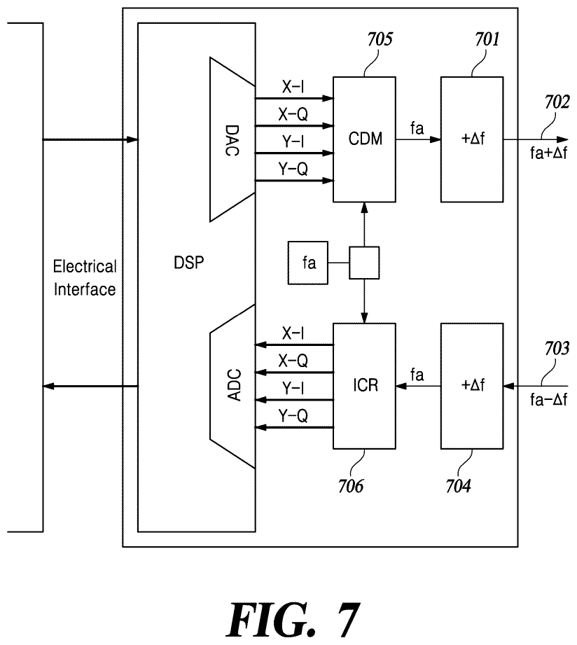

The optical communication system transmits and receives optical signals in the coherent optical communication system according to an embodiment of the present disclosure. The first transceiver in FIG. 6 corresponds to the first coherent optical transceiver 401 in FIG. 4, and corresponds to the first coherent optical transceivers in FIGS. 7, 9, 11, 13, and 14, which will be described later.

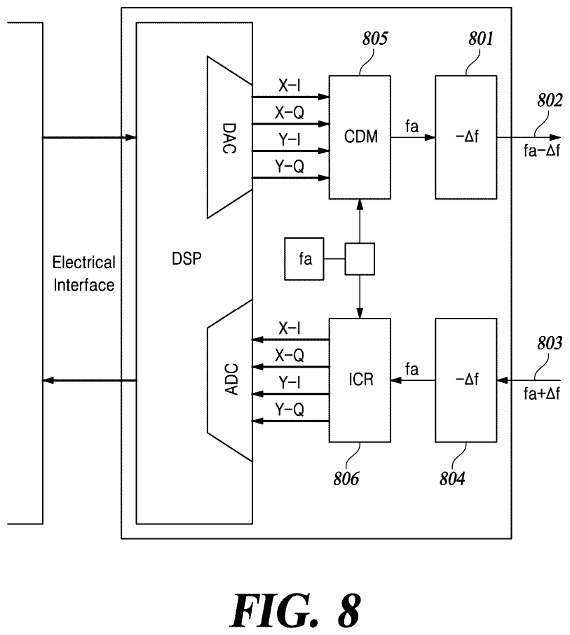

The second transceiver corresponds to the second coherent optical transceiver 402 in FIG. 4, and corresponds to the second coherent optical transceivers in FIGS. 8, 10, 12, 13, and 14, which will be described later.

In step 601, the first transceiver of the optical communication system generates the first optical signal set to the first wavelength.

In step 602, the first transceiver of the optical communication system applies the frequency shift by +Δf to the first optical signal.

In step 603, the first transceiver of the optical communication system transmits the first optical signal frequency-shifted by +Δf to the second transceiver through the single optical fiber link. The second transceiver receives the optical signal by applying the frequency shift by −Δf to the first optical signal frequency-shifted by +Δf.

In step 604, in the opposite direction, the first transceiver of the optical communication system receives, from the second transceiver, the second optical signal that is set to the first wavelength and applied frequency shift of −Δf.

FIGS. 7 and 8 are structural diagrams of a coherent optical transceiver to which an embodiment of the present disclosure is applied.

FIG. 7 corresponds to the first coherent optical transceiver 401 of FIG. 4. FIG. 8 corresponds to the second coherent optical transceiver 402 of FIG. 4.

The CDMs 705, 805 modulate and convert the electrical signals X-I, X-Q, Y-I, Y-Q into optical outputs and outputs fa.

The ICRs 706, 806 convert the optical input fa into electrical signals X-I, X-Q, Y-I, Y-Q and output them.

The first frequency shifter 701 in FIG. 7 shifts the optical output fa by +Δf to output a fa+Δf optical signal.

When the fa−Δf optical signal is input, the second frequency shifter 704 of FIG. 7 shifts by +Δf and outputs the fa optical signal to the ICR 706.

The third frequency shifter 801 in FIG. 8 shifts the optical output fa by −Δf to output a fa−Δf optical signal.

When the fa+Δf optical signal is input, the fourth frequency shifter 804 of FIG. 8 shifts by −Δf and outputs the fa optical signal to the ICR 806.

The first frequency shifter 701 and the second frequency shifter 704 in FIG. 7 and the third frequency shifter 801 and the fourth frequency shifter 804 in FIG. 8 may be implemented in an electro-optic, acousto-optic, or the like manner.

In addition, the first frequency shifter 701 and the second frequency shifter 704 may be implemented by integrating with the optical transmitter 705 and the optical receiver 706.

In addition, the third frequency shifter 801 and the fourth frequency shifter 804 may be implemented by integrating with the optical transmitter 805 and the optical receiver 806.

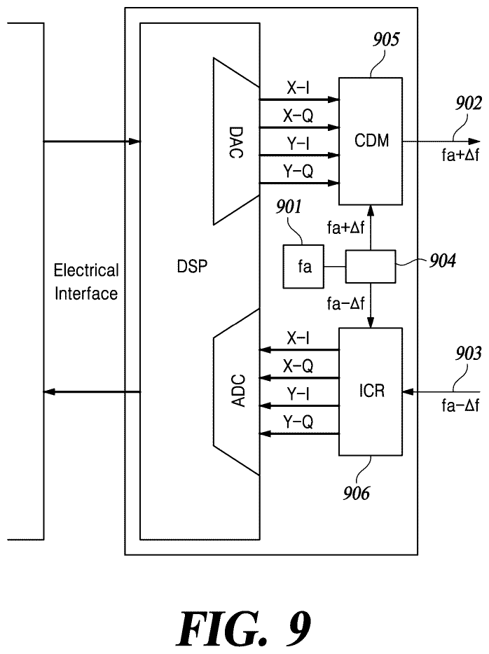

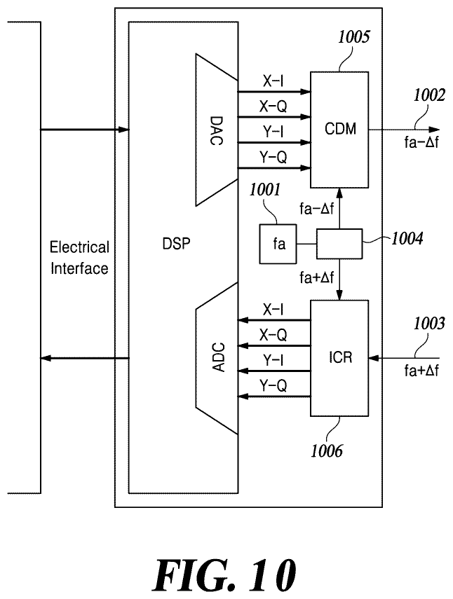

FIGS. 9 and 10 show another example of a coherent optical transceiver structure to which an embodiment of the present disclosure is applied.

The coherent optical transceiver of FIG. 9 corresponds to the first coherent optical transceiver 401 of FIG. 4, and the optical transceiver in FIG. 10 corresponds to the second coherent optical transceiver 402 of FIG. 4.

It is a structure in which the output of the LDs 901, 1001 is directly connected to the frequency shifters 904, 1004.

Frequency shifter 904 may be configured with frequency shifter of Δf and frequency shifter −Δf, respectively. The CDM 905 mixes the electrical signals X-I, X-Q, Y-I, Y-Q and fa+Δf to modulate and convert them into an optical output fa+Δf.

The frequency shifter 1004 may be configured with frequency shifter of −Δf and frequency shifter Δf, respectively. The ICR 1006 compensates for problems caused by converting the optical input fa−Δf and the frequency-shifted Δf into electrical signals X-I, X-Q, Y-I, Y-Q.

In an embodiment of the present disclosure a frequency shifter 1004 with two complementary outputs is used, one output with Δf and the other output with −Δf. In addition, the frequency shifter 904 of FIG. 9 may be implemented by integrating with components of the optical transmitter 905 and the optical receiver 906. The frequency shifter 1004 of FIG. 10 may be implemented by integrating with components of the optical transmitter 1005 and the optical receiver 1006.

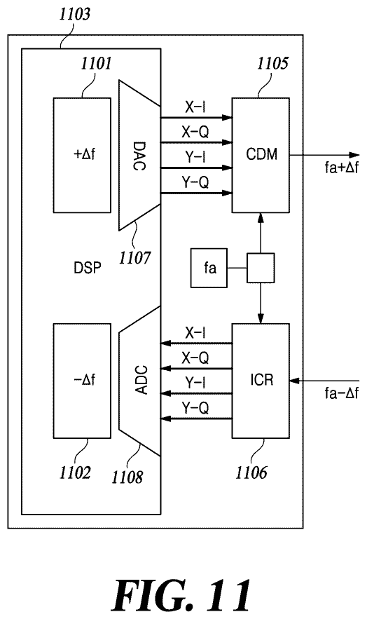

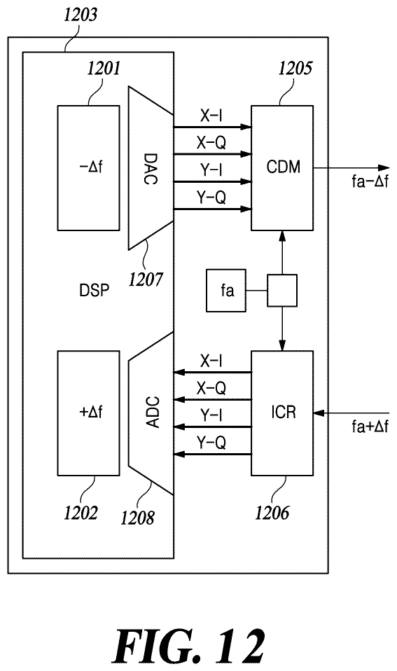

FIGS. 11 and 12 further show another example of a coherent optical transceiver structure to which an embodiment of the present disclosure is applied.

FIG. 11 corresponds to the first coherent optical transceiver 401 of FIG. 4. FIG. 12 corresponds to the second coherent optical transceiver 402 of FIG. 4.

FIGS. 11 and 12 are frequency-shifted in the DSP 1103.

The frequency shifter 1101 in the DSP 1103 shifts the baseband signal in the frequency domain by +Δf, and outputs it through digital-to-analog converter (DAC) 1107 to implement the center frequency of the light output as fa+Δf. Here, the CDM 1105 modulates and converts the electrical signals X-I, X-Q, Y-I, Y-Q to optical output fa+Δf.

In the receiver, the frequency difference between the laser light source fa and the center frequency of the received signal fa−Δf occurs by −Δf, so that it is shifted in the frequency domain by −Δf in the frequency shifter 1102 in the DSP 1103 via the ADC 1108 to compensate for problems occurring in the optical transmission line. Here, the ICR 1105 converts the light input (fa−Δf) into electrical signals (X-I, X-Q, Y-I, Y-Q).

The frequency shifter 1201 in the DSP 1203 shifts the baseband signal in the frequency domain by −Δf, and outputs it through digital-to-analog converter (DAC) 1207 to implement the center frequency of the light output as fa−Δf. Here, the CDM 1205 modulates and converts the electrical signals X-I, X-Q, Y-I, Y-Q to optical output fa+Δf.

In the receiver, the frequency difference between the laser light source fa and the center frequency of the received signal fa+Δf occurs by +Δf, so that it is shifted in the frequency domain by +Δf in the frequency shifter 1202 in the DSP 1203 via the ADC 1208 to compensate for problems occurring in the optical transmission line. Here, the ICR 1205 converts the light input (fa+Δf) into electrical signals (X-I, X-Q, Y-I, Y-Q).

As described above, the embodiments of the present disclosure are capable of implementing frequency shifting in various manners, and by applying this to the coherent optical transceiver, it may operate as the coherent optical transceiver capable of bi-directional optical transmission.

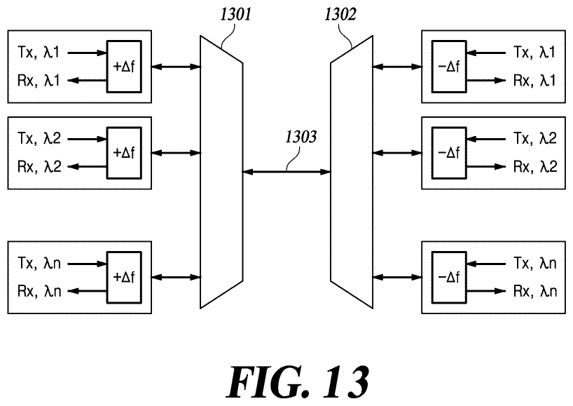

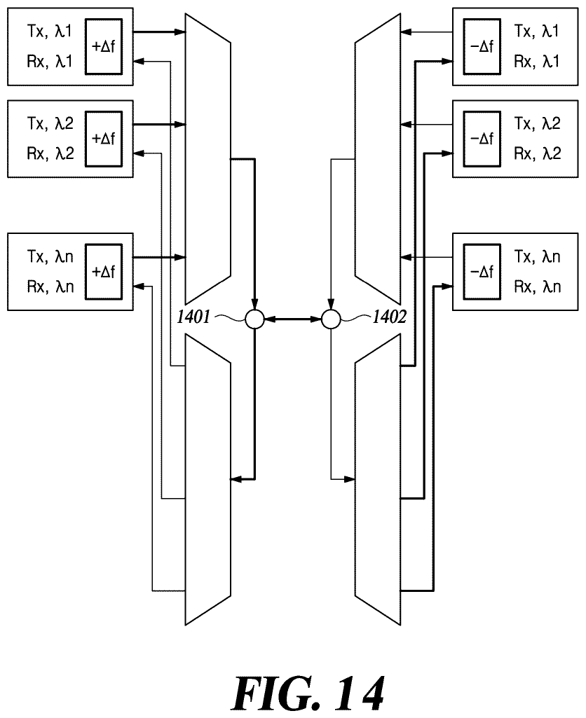

FIGS. 13 and 14 show another example of bi-directional WDM optical transmission to which an embodiment of the present disclosure is applied.

FIG. 13 is a schematic diagram of bi-directional WDM optical transmission using a bi-directional coherent optical transceiver.

Referring to FIG. 13, each of the first plurality of bi-directional optical transceivers is connected with a first WDM 1301, and each of the second plurality of bi-directional optical transceivers is coupled with a second WDM 1302. Here, the first WDM 1301 and the second WDM 1302 are connected via a single optical fiber link 1303.

Compared with FIG. 2, it may be confirmed that FIG. 13 uses the same wavelength band in both directions. By using the frequency shifting function of the coherent optical transceiver in the method according to the embodiment of the present disclosure, the center frequencies of the bi-directional signals are staggered, thereby solving the problem of back-reflection.

Referring to FIG. 14, instead of coupling an optical circulator to each bi-directional coherent optical transceiver, optical circulators 1401, 1402 are coupled to the input and output portions of the single optical fiber link 405. Compared to the case of FIG. 13, the number of optical circulators may be significantly reduced in the scheme of FIG. 14.

Referring to FIG. 14, the optical input/output (e.g., 702, 703) of the coherent optical transceiver in FIG. 7 to FIG. 13 may be connected to the optical circulators 1401, 1402, and may be used to transmit according to the direction of light propagation. Thereby, it is bi-directionally coupled with the single optical fiber link 405 of FIG. 4.

A method for implementing a coherent optical transceiver capable of bi-directional optical transmission according to an embodiment of the present disclosure may be implemented as illustrated in FIG. 4 to FIG. 14, but is not limited thereto.

At least some of the components described in the exemplary embodiments of the present disclosure may be implemented as hardware elements including at least one of a digital signal processor (DSP), a processor, a controller, an application-specific IC (ASIC), a programmable logic device (FPGA, etc.), and other electronic devices, or combinations thereof. In addition, at least some functions or processes described in the exemplary embodiments may be implemented in software, and the software may be stored in a recording medium. At least some components, functions, and processes described in the exemplary embodiments of the present disclosure may be implemented by a combination of hardware and software.

The method according to the exemplary embodiments of the present disclosure may be written as a computer-executable program, and may also be implemented as various recording media such as a magnetic storage medium, an optical reading medium, and a digital storage medium.

Implementations of the various techniques described herein may be implemented in digital electronic circuitry, or in computer hardware, firmware, software, or in combinations of thereof. Implementations may be implemented as a computer program product, i.e., a computer program tangibly embodied in an information carrier, for example, in a machine-readable storage device (computer-readable medium) or in a propagated signal, for processing by, or to control the operation of, data processing apparatus, e.g., a programmable processor, a computer, or multiple computers. A computer program, such as the computer program(s) described above, may be written in any form of programming language, including compiled or interpreted languages, and it may be deployed in any form, including as a stand-alone program or as a module, component, subroutine, or other unit suitable for use in a computing environment. A computer program may be deployed to be processed on one computer or on multiple computers at one site or distributed across multiple sites and interconnected by a communication network.

Processors suitable for the processing of computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer will include, or be coupled to receive data from or transmit data to, or both, one or more mass storage devices for storing data, e.g., magnetic, magneto-optical disks, or optical disks. Information carriers suitable for embodying computer program instructions and data include, by way of example, semiconductor memory devices, for example, magnetic media such as hard disks, floppy disks, and magnetic tape, optical media such as compact disk read only memory (CD-ROM), digital video disk (DVD), magneto-optical media such as floptical disk, read only memory (ROM), random access memory (RAM), flash memory, erasable programmable ROM (EPROM), electrically erasable programmable ROM (EEPROM), and the like. The processor and the memory may be supplemented by, or incorporated in, special purpose logic circuitry.

The processor may perform an operating system and a software application performed on the operating system. Further, the processor device may access, store, manipulate, process, and generate data in response to execution of the software. For ease of understanding, a processor device may be described as being used singly, but a person skilled in the art may know that the processor device may include a plurality of processing elements and/or a plurality of types of processing elements. For example, the processor device may include a plurality of processors or one processor and one controller. Other processing configurations are also possible, such as parallel processors.

Moreover, non-transitory computer-readable media may be any available media that may be accessed by a computer and includes both computer storage media and transmission media.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to obtain desirable results. In certain cases, multitasking and parallel processing may be advantageous. Moreover, the separation of various device components in the embodiments described above should not be understood as requiring such separation in all embodiments, and it should be understood that the described program components and devices may generally be integrated together in a single software product or packaged into multiple software products.

Meanwhile, the embodiments of the present disclosure disclosed in this specification and drawings are merely specific examples presented to help understanding and are not intended to limit the scope of the present disclosure. It is obvious to a person skilled in the art that other variations based on the technical idea of the present invention may be implemented in addition to the embodiments disclosed herein.

The protection scope of the present embodiment is to be construed according to the following claims, and all technical ideas within the scope equivalent thereto are construed as being included in the scope of rights of the present embodiment.

What is claimed is:

1. A method for transmitting and receiving an optical signal in a coherent optical communication system, comprising:
transmitting, from a first transceiver, a first optical signal set to a first wavelength to a second transceiver; and
receiving, from the second transceiver, a second optical signal set to the first wavelength.

2. The method of claim 1, wherein:
the first transceiver comprises a first frequency shifter that shifts the first signal in frequency by a predetermined frequency.

3. The method of claim 2, wherein:
the second transceiver comprises a second frequency shifter that shifts the second signal in frequency by a predetermined frequency.

4. The method of claim 1, wherein:
the first transceiver and the second transceiver are connected by a single optical fiber link.

5. The method of claim 4, wherein:
bi-directional signals in the single optical fiber link are frequency-shifted in different directions.

6. The method of claim 1, wherein:
the first transceiver and the second transceiver each comprise one laser light source.

7. The method of claim 5, wherein:
when the output of the laser light source is connected to one frequency shifter, the one frequency shifter outputs a center frequency of light output as one of fa+Δf and fa−Δf;
wherein fa denotes an original light output frequency (fa=c/λ, where c represents the speed of light and λ represents a wavelength) and Δf denotes a frequency shift by a predetermined frequency.

8. The method of claim 1, wherein:
the first transceiver and the second transceiver transmit and receive an optical signal using the same wavelength.

9. The method of claim 4, wherein:
each of the plurality of first transceivers is connected to a plurality of second transceivers via wavelength division multiplexing (WDM).

10. The method of claim 9, wherein:
if the plurality of first transceivers and the plurality of second transceivers are present and bi-directional WDM optical transmission is used, an optical circulator is connected to an input portion and an output portion of the single optical fiber link, respectively.

11. An apparatus for transmitting and receiving an optical signal in a coherent optical communication system, comprising:
a memory comprising instructions; and
a processor that, by execution of the instructions, transmits, from a first transceiver, a first optical signal set to a first wavelength to a second transceiver, and receives, from the second transceiver, a second optical signal set to the first wavelength.

12. The apparatus of claim 11, wherein:
the first transceiver comprises a first frequency shifter that shifts the first signal in frequency by a predetermined frequency.

13. The apparatus of claim 12, wherein:
the second transceiver comprises a second frequency shifter that shifts the second signal in frequency by a predetermined frequency.

14. The apparatus of claim 11, wherein:
the first transceiver and the second transceiver are connected by a single optical fiber link.

15. The apparatus of claim 14, wherein:
bi-directional signals in the single optical fiber link are frequency-shifted in different directions.

16. The apparatus of claim 11, wherein:
the first transceiver and the second transceiver each comprise one laser light source.

17. The apparatus of claim 15, wherein:
when the output of the laser light source is connected to one frequency shifter, the one frequency shifter outputs a center frequency of light output as one of fa+Δf and fa−Δf;
wherein fa denotes an original light output frequency (fa=c/λ, where c represents the speed of light and λ represents a wavelength) and Δf denotes a frequency shift by a predetermined frequency.

18. The apparatus of claim 11, wherein:
the first transceiver and the second transceiver transmit and receive an optical signal using the same wavelength.

19. The apparatus of claim 14, wherein:
each of the plurality of first transceivers is connected to a plurality of second transceivers via wavelength division multiplexing (WDM).

20. The apparatus of claim 19, wherein:
if the plurality of first transceivers and the plurality of second transceivers are present and bi-directional WDM optical transmission is used, an optical circulator is connected to an input portion and an output portion of the single optical fiber link, respectively.
